(19) United States
(12) Patent Application Publication
(10) Pub. No.: US 2005/0035305 A1
(43) Pub. Date: Feb. 17, 2005

(54) Iterative optical based histology

(76) Inventors: David Kleinfeld, La Jolla, CA (US); Jeffrey Squier, Golden, CO (US); Philbert Tsai, La Jolla, CA (US)

Correspondence Address: Schwegman, Lundberg, Woessner & Kluth, P.A., P.O. Box 2938, Minneapolis, MN, 55402, US

(21) Appl. No.: 10/886,940

(22) Filed: Jul. 8, 2004

Related U.S. Application Data
(63) Continuation of application No. PCT/US03/00777, filed on Jan. 10, 2003.
(60) Provisional application No. 60/347,625, filed on Jan. 10, 2002.

(51) Int. Cl. G01N 1/00

(52) U.S. Cl. 250/458.1; 435/7.1

(57) ABSTRACT

Femtosecond laser pulses are used to iteratively cut and image fixed as well as exsanguinated fresh tissue. Such images help to automate three-dimensional histological analysis of biological tissue. Cuts are accomplished with approximately 0.3 to 100 microJoule pulses to ablate tissue with one-micrometer precision. Permeability, immunoreactivity, and optical clarity of the remaining tissue is retained after pulsed laser cutting. Samples from transgenic mice that express fluorescent proteins retained their fluorescence to within micrometers of the cut surface.

### RELATED APPLICATIONS

This application is a continuation under 35 U.S.C. 111 (a) of International Application No. PCT/US03/00777 filed Jan. 10, 2003 and published in English as WO 03/060477 A2 on Jul. 24, 2003, which claims priority from U.S. Provisional Application Ser. No. 60/347,625 filed Jan. 10, 2002, which applications and publication are incorporated herein by reference.

### GOVERNMENT FUNDING

The invention described herein was made with U.S. Government support under Grant Number NS41096 awarded by the National Institute of Neurological Disease and Stroke and under Grant Number DBI-9987257 awarded by the National Science Foundation. The United States Government has certain rights in the invention.

### FIELD OF THE INVENTION

The present invention relates to histology, and in particular to a laser-based optical histology.

### BACKGROUND OF THE INVENTION

To obtain three dimensional representations as by current methods of histology of biological tissue, such as brains, the tissue is usually frozen, and then sliced, and then individual slices are mounted on slides such that imaging and analysis are typically performed subsequent to the completion of the mounting. Current methods of performing histology require that the tissue be frozen, or infiltrated with paraffin, prior to cutting with a mechanical device for routine cuts of 50 micrometers or less. This results in shrinkage and distortion of the tissue and thus the loss of information contained in the slice. Further, images need to be realigned to ensure proper registration and accurate representation of the tissue.

Previous attempts at automated histology made use of entire frozen brains in which a knife was used to remove a slice from the top surface and the remaining surface was imaged after each slice. The relatively large thickness of each slice, typically 25 micrometers or more and the relatively low resolution of the imaging apparatus led to a loss in information.

Previous applications of lasers for the ablation of tissue used continuous wave or long pulses, i.e., nanosecond duration. This leads to heating and collateral tissue damage. The use of femtosecond pulses to ablate relatively large craters in brain tissue has been previously demonstrated.

### SUMMARY OF THE INVENTION

Femtosecond laser pulses are used to iteratively cut and image fixed as well as exsanguinated fresh tissue. Such images help to automate three-dimensional histological analysis of biological tissue. Cuts are accomplished with 0.3 to 100 microjoule pulses to ablate tissue with one-micrometer precision. Permeability, immunoreactivity, and optical clarity of the remaining tissue is retained after pulsed laser cutting. Samples from transgenic mice that express fluorescent proteins retained their fluorescence to within micrometers of the cut surface.

Imaging of exogenous dyes that bind to specific proteins or nucleic acids, or imaging of endogenous fluorescent labels is accomplished with 0.2 to 2 nanoJoule pulses and conventional two-photon laser scanning microscopy (TPLSM) in one embodiment. A stack of diffraction-limited images are obtained through a depth of 100 micrometers or more below the cut surface. The surface is then re-cut, optionally restained, and imaged until the entire block of tissue has been imaged and ablated. Three-dimensional spatial patterns of protein or nucleic acid expression are reconstructed with submicrometer resolution for the purposes of genomics, proteomics, and cellular architectonics. As a demonstration, the technique is applied to neuronal tissue to reconstruct the microvasculature within a region of the brain.

### BRIEF DESCRIPTION OF THE DRAWINGS

FIG. 1 is a block flow diagram of an automated histology of a tissue sample.

FIG. 2 is a block schematic diagram of an apparatus for cutting, staining and imaging a tissue sample; the dichroic mirror and collection optics for images is not shown.

FIG. 3 is a block schematic diagram showing further detail of chamber and imaging components of FIG. 2.

FIG. 4 is a block schematic diagram of the chamber of FIG. 3.

FIG. 5 is a side view representation of lateral ablation of a sample.

FIG. 6 is a perspective block diagram of a system for performing the ablation of FIG. 5.

FIG. 7 is a perspective block diagram of a system for performing a vertical ablation of a sample.

FIG. 8 is a side block representation of tissue ablation using the system of FIG. 7.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

Functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

Automated three-dimensional histological analysis of tissue, such as brain tissue, uses ultrashort laser pulses of femtosecond or picosecond duration to iteratively ablate or cut and image fixed as well as fresh exsanguinated tissue. Cuts are accomplished with 0.3 to 100 microJoule pulses to ablate tissue with micrometer precision in either a vertical or lateral position. In one embodiment, the permeability, immunoreactivity, and optical clarity of the tissue is retained after pulsed laser cutting. Further, samples from transgenic mice that express fluorescent proteins retained their fluorescence to within micrometers of the cut surface. Imaging of exogenous or endogenous fluorescent labels down to 100 micrometers or more below the cut surface is accomplished with ultrashort laser pulses and conventional TPLSM. A three dimensional digital record of labeled tissue is created with this analysis.

An overview of the process, followed by a description of an apparatus for performing such histological analysis of tissues is provided. This is followed by further detail regarding methods of using such apparatus to perform histological analysis.

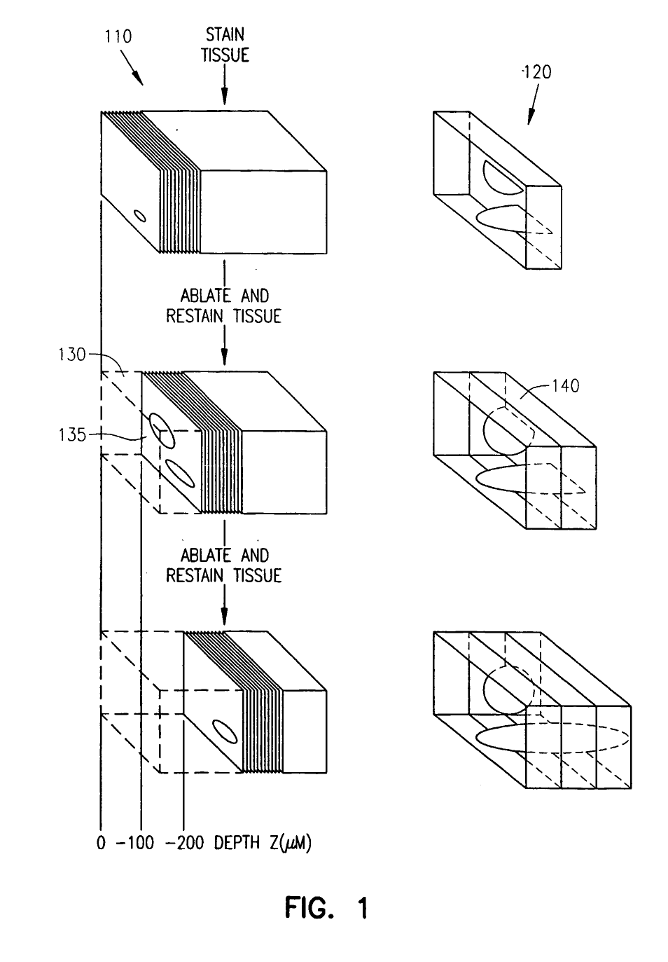

FIG. 1 illustrates an iterative process by which tissue is imaged and cut in all-optical histology. A tissue sample in column 110 containing two fluorescently labeled structures is imaged by conventional TPLSM to collect optical sections through the ablated surface. Sections are collected until scattering of the incident light reduces the signal-to-noise ratio below a useful value; typically this occurs at 150 micrometers in fixed tissue. Labeled features in the resulting stack of optical sections are digitally reconstructed as represented in column 120. Image resolution and software for building the three dimensional representation may be selected and varied as desired.

The top layer of the now-imaged region 130 of the tissue is cut away with amplified ultrashort laser pulses that are focused to an intensity at or above the ablation threshold of the material to expose a new surface 135 for imaging. The sample is again imaged down to a maximal depth, and the new optical sections 140 are added to the previously stored stack. The process of ablation and imaging is again repeated so that the structures of interest can be fully sectioned and reconstructed. A staining step may be used between ablations of tissue layers for better imaging. In further embodiments, the tissue samples are transgenically labeled with an intrinsic fluorophore or chromophore, and further staining is not performed prior to imaging the tissue.

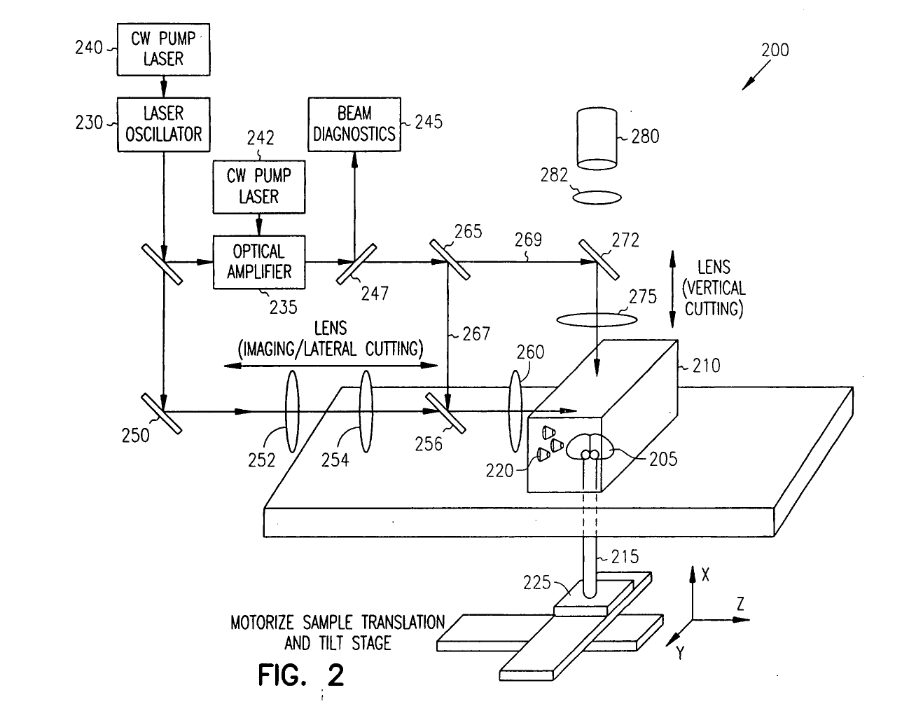

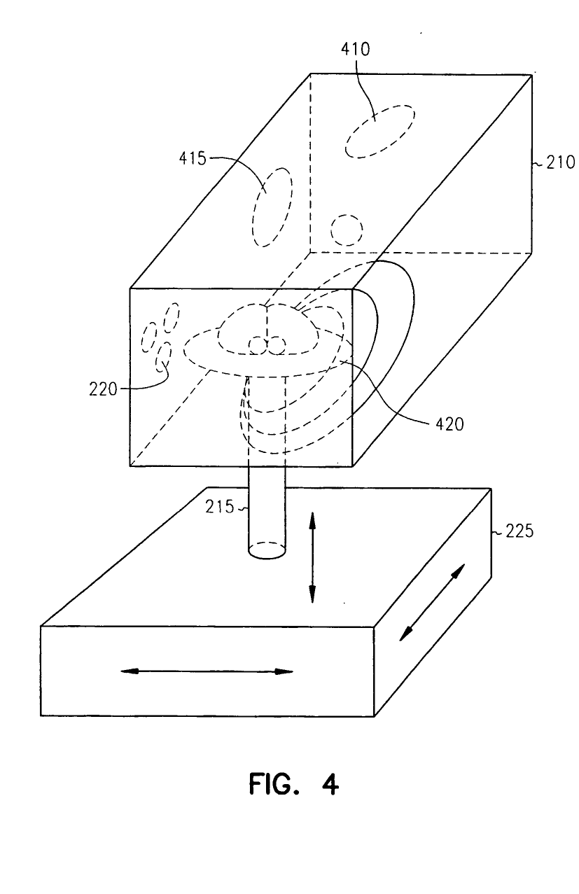

FIGS. 2, 3 and 4 are schematic diagrams of hardware and major optical beam line for automated tissue cutting, staining, and imaging indicated generally at 200. Each figure is numbered consistently, with new numbers in a figure beginning with the number of the figure. The sample tissue, such as a rodent brain 205, is held in a sealed chamber 210 with multiple ports. A port 410 on the top is used for vertical cutting with low numerical (long focal length). A port 415 on the front is used for lateral cutting and imaging. A port 420 on the bottom is for a sample post 215. Additional ports with nozzles 220 are used for lines to spray and/or regulate fluids for the staining of the tissue 205. The tissue moves on a 5-dimensional stage (translation along X, Y, and Z Cartesian axes plus rotation along the X and Y axes) 225 that has a fixed, leak-proof enclosure 210. In one embodiment, connections into and out of the fixed enclosure 210 are through water-proof gaskets. The stage (225) translation is under computer control through stepper motors and the stage rotation is under computer control through motorized goniometers.

In one embodiment, a laser oscillator 230 is Titanium:Sapphire with a pulse width of approximately 150 femtoseconds that is used both as the source for a two-photon laser scanning microscope, which is used to optically section the tissue, and as a seed for a regenerative optical amplifier 235. Pump lasers 240 and 242 are continuous wave (CW) solid state lasers. Pump laser 240 in combination with laser oscillator 230 and various other optics form the two-photon laser scanning microscope. Optical amplifier 235 and pump laser 242 along with various optics form the sample optical cutting device.

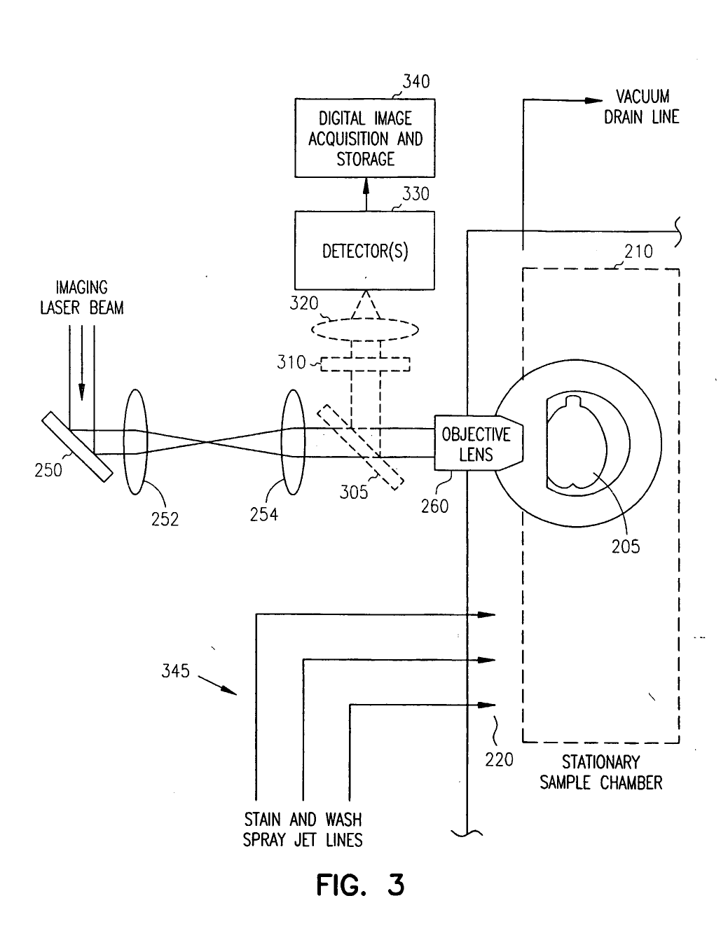

Beam diagnostics 245 include a power meter, spectrometer, and autocorrelator, which receive light from the optical amplifier via a beamsplitter 247. In one embodiment, the objective has a high numerical aperture (NA) in the range from 0.2 to 1.0 NA, which are typically available with standard water-immersion objectives. The choice of the numerical aperture is based on considerations that tie the NA of the microscope objective to the laser penetration depth at a given location of tissue. Detection optics and detector are shown schematically in FIG. 3. Computer control and data acquisition and digitization circuitry are not shown in detail.

Optics for the sample cutting device provide two separate paths for either vertical or lateral cutting. A first flip mirror 265 and a second flip mirror 256 are used to route laser pulses either in a lateral path 267, with both mirrors up, or a vertical path 269, with both mirrors down. Pulses on the vertical path 269 are reflected at 272 through an objective 275 into the vertical port 410 toward the sample 205. The lateral cutting optic path 267 directs pulses to the flip mirror 256 through objective 260 and port 415 onto the sample 205, thus using the same objective port and shared beam optics to both ablate and image the tissue.

A camera or other imager 280 along with camera lens 282 is used to obtain optical images of the sample for alignment and diagnostic purposes.

Major illumination optics, including the scanners 250, scan lens 252, tube lens 254, and objective 260 are shown for the two-photon laser scanning microscope. FIG. 3 provides a schematic of detection optics comprising a dichroic mirror 305, a mixture of colored glass and interference filters 310, collection lens 320 and detectors 330, all receiving photons through the objective lens 260 from the sample. A digital image acquisition and storage system is provided to store sections in the form of digital images. Such a system comprises a computer system and suitable acquisition software and imaging software to combine sections into a three dimensional representation of the sample. With additional hardware and optics, multiple wavelengths of light may be detected at once.

Stain and wash spray jet lines indicated generally at 345 provide a slowly flowing physiological saline buffer on the sample to wash away debris and prevent it from accumulating and interfering with imaging. The stain and wash spray jet lines are coupled through one or more of the ports/nozzles 220.

In one embodiment, the tissue is stained in situ, and optically sectioned between successively ablated surfaces, so that alignment is maintained. Typically, one hundred, one micrometer thick optical sections that span 100 micrometers of tissue are obtained between successive ablations.

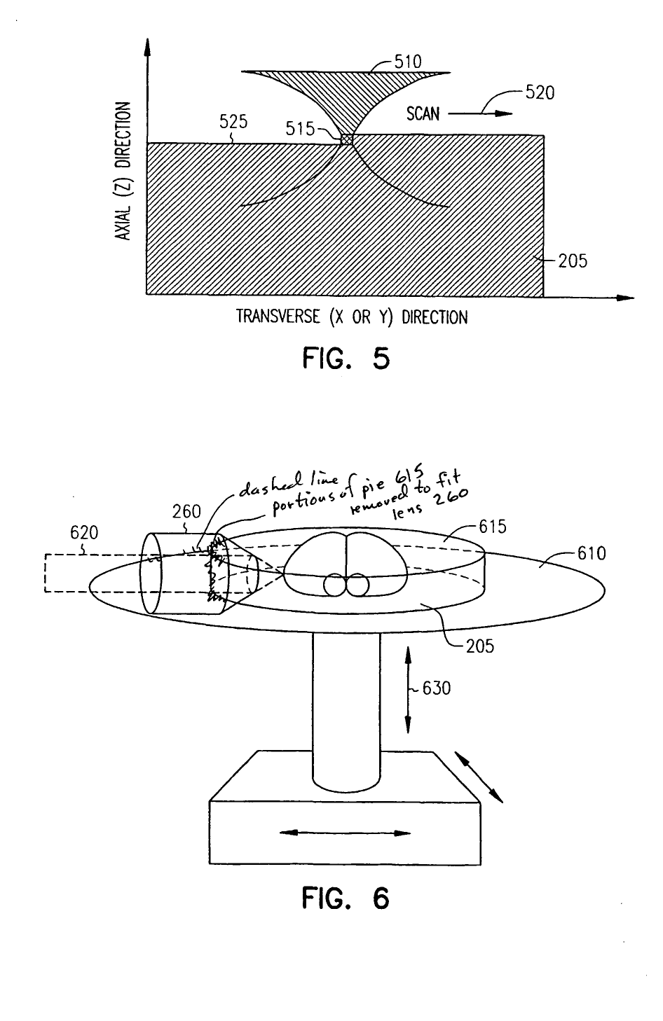

FIG. 5 illustrates various aspects of the amplified ultrashort laser ablation and subsequent imaging in a lateral mode. Cutting along a face that is perpendicular to a beam (lateral cutting) is performed with high energy pulses 510, i.e., typically 0.3 to 100 microJoules, and high numerical aperture objectives 260, 272, i.e., typically 0.2 to 1.0 NA, to ablate small volumes, i.e., typically 10 to 100 femtoliters, with relatively high precision. A crosshatched focus region 515 approximately corresponds to the ablation volume at the threshold energy for ablation. The beam is focused on the surface of the tissue or just deep to the surface. The tissue is mounted on a goniometer to allow leveling and alignment of the tissue surface relative to the optical axis of the laser beam. A motorized stage allows movement to effect continuous tissue removal at depths of approximately 5 to 20 micrometer.

The laser is scanned in a direction as indicated by an arrow 520, and in some embodiments, a raster scan of a desired surface is performed. Previously scanned areas are referred to as a cut face, as shown at 525. The depth of ablation may be varied as desired, down to approximately 1 micrometer in one embodiment, but typically from 5 to 20 micrometers with a current resolution of approximately 1 micrometer. Such ranges are provided for example only. Smaller and larger depths may also be obtained in further embodiments.

FIG. 6 further illustrates the configuration of the tissue 205 and tissue platform 610 for cutting with a high NA objective 260. The tissue is embedded in low melting point agarose 615 (typically 2% (w/v) in saline). The focus of laser beam 620 is adjusted by changing a height (axial dimension) 630 of the objective and the tissue is ablated by smoothly moving the tissue platform in a raster pattern (lateral dimensions) through the use of computer controlled stepping motors. Alternately, a scan mirror can be used in combination with the motors.

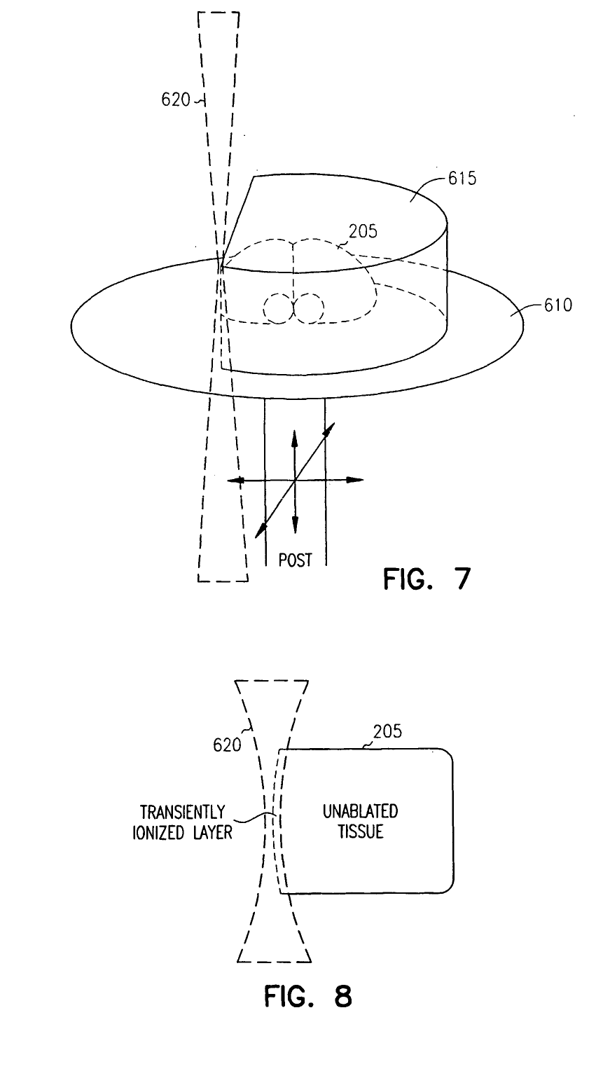

FIG. 7 illustrates geometry and beam profile for vertical tissue cutting, which is cutting along a face that is parallel to the beam. The tissue 205 is embedded in low melting point agarose 615 (typically 2% (w/v) in saline), aligned so that the focus of the ultrashort, high energy laser light 620 lies up to 5 millimeter below the uncut sample surface, and cut by smoothly varying the tissue platform, as above.

FIG. 8 illustrates the vertical cutting process. The ultrashort, high energy laser pulses may transiently ionize the sample 205 and form a plasma layer as part of the ablation process.

Optimization of an all optical histology may be done using an empirical determination of pulse rates and laser energies, durations and wavelengths that produce a smooth surface. The evaluation of these cutting parameters relies primarily on TPLSM of the cut block face at a range of magnifications in one embodiment. Imaging is done at wavelengths that selectively highlight different features. Tissue autofluorescence is enhanced by illumination of the tissue sample near a wavelength of 750 nanometers, the exogenous labels fluorescein and acridine orange are excited with a wavelength of 800 nanometers, and the endogenous label cyan fluorescent protein (CFP) is excited with a wavelength of 850 nanometers. Both ablation and imaging are performed within the same system in one embodiment, but imaging data may also be obtained by transfer of the samples to a separate imaging system.

Ablation Parameters.

There are five parameters that may be optimized for the ablation process: pulse intensity, scan speed, repetition rate, axial step size, and wavelength. The first, the ablation threshold intensity for the preparation, is most often determined empirically. The second, the rate of scanning, is set by the speed of the tissue movement. This changes the number of pulses delivered to a voxel in the tissue and is coupled to the third parameter, the repetition rate. The fourth, the axial step size between ablated layers, depends on the intensity relative to threshold and also on the scan speed. The last parameter, the wavelength, is chosen to avoid the absorption bands of intrinsic chromophores.

To establish threshold values of the energy that is required for ablation, fixed tissue from a sample, such as rat neocortex is used to generate an array of ablation sites as both the energy per pulse and the number of pulses are systematically varied. The ablations take the form of small holes of graded sizes with the largest holes made by, on the order of, 510 consecutive 5 microjoule pulses.

A threshold energy of 0.63 microjoules for a single pulse application corresponds to a fluence of F_{T}≈10 Joules per square centimeter for the beam parameters. The ablation volume has an elongated profile near threshold. Further, an increased number of laser pulses weakly compensates for lower pulse energies, i.e. by approximately 4-fold for 130 pulses. Thus lateral cutting in one embodiment is most efficient, in terms of total energy expenditure, with one or few pulses whose energy lies above the threshold value. This implies that the scan rate should be chosen to ensure approximately one area of ablation per pulse. For a 0.2 NA lens and the 1.2 kiloHertz repetition rate of the amplifier, the maximum scan rate is approximately 5 millimeters per second. Scan rates will vary with different parameters.

The fidelity with which the point ablations could form lines when fixed brain tissue is translated across the beam that is focused at the surface of the tissue may also be determined. The fine scale of these cuts is on the order of 2 micrometers in diameter. The corresponding troughs to each channel measure approximately 6 micrometers to their deepest point. This sets the scale for the finest cuts that can be made and also establishes the capacity to make reproducible long channels in brain tissue for these parameters. The roughness of the ablated surface may be evaluated in order to determine if two photon laser scanning microscopy (TPLSM) would be an effective imaging tool with brain tissue that was prepared with laser ablation. In particular, a sufficiently great roughness would detract from the advantages of TPLSM imaging. In one example, large channels, several hundred micrometers in width, were ablated into fixed neocortex from mouse using an axial step size, or z-step, of 10 micrometers. The surface of the ablated channel was stained with a fluorescent lipid analog and, subsequently, the tissue was mechanically cut along a plane perpendicular to the length of the ablated channel. A short strip along the ablated surface was imaged at high magnification and the variations in height were analyzed to quantify the roughness of the surface. A root-mean-square deviation of the ablated surface was estimated to be 1.1±0.1 micrometers (mean±standard error of the mean). For comparison, similarly fixed neocortical tissue from mouse was equilibrated in 30% (w/v) sucrose, rapidly frozen, and cut with a cryostat with a C-profile knife. An analysis of the surface roughness of a block face from which 10 micrometer sections had been cut yielded a roughness of 0.8±0.1 micrometers. A final comparison was made with similarly fixed but unfrozen tissue block that was faced off with a Vibratome™. Here, the surface exhibited some large-scale variations, but on the fine-scale of one to one hundred micrometers the local roughness was approximately 1 micrometer. Thus the roughness of the optical ablated surface is similar to that of surfaces that are cut frozen or unfrozen with traditional histological knives. The roughness of a block face that is trimmed with amplified ultrashort laser pulses appears to be well within the depth of imaging with TPLSM, so that the two methods are compatible.

Although the nonlocalized heating is believed to be negligible for ablations with ultrashort laser pulses, i.e., for pulses less than 10 picoseconds in duration, testing was performed to determine if scaling up the volume of ablations in brain tissue preserves the imaging properties of the preparation. Ablation of millimeter-sized slabs was considered in fixed neocortical tissue from rat, for which an axial step size of 20 micrometers was used. Sets of five consecutive ablation scans were performed to remove slabs of approximately 100 micrometers in total thickness. This process was repeated to form a staircase pattern of remaining tissue. That ablated tissue appeared to be readily cleared by the buffer, so that debris did not accumulate or stick to the cut surfaces. At the macroscopic level, the cut surfaces appeared flat, with sharply defined walls. A side view of the cuts was obtained in tissue that was en block stained after ablation with a lipid soluble fluorescein derivative dye showed edges of the cuts appear smooth. Similar results were found for cuts made in the fixed adult mouse brain.

As a further test of the ability for laser ablation to reliably remove tissue from unfrozen brains, the methods were tested with embryonic mouse brain. This tissue is particularly difficult to section with traditional techniques, largely because of the low content of glia and connective tissue and the high content of fluid. Yet such tissue, with its relatively high transmission of light, appears to be ideally suited for the all-optical histology technique described here. The large-scale ablation and imaging of perfused and fixed mouse embryos were considered. The embryos were mounted in agarose with the lateral surface of the head exposed. Multiple ablation passes at increasing axial depth were performed until over 800 micrometers of tissue depth was removed. Despite the fragility of unfrozen embryonic brain tissue, the gross structure of the brain and lateral ventricle appeared normal after large-scale laser-tissue removal.

Photo-damage was also tested. Retention of normal tissue properties in the adjacent, unablated regions is obtained using ultrashort laser pulses for histology. Collateral damage in the tissue immediately adjacent to the ablation was evaluated with with four metrics: (i) Preservation of physical integrity of the cell surface and cell organelles as assessed by application of fluorescent probes; (ii) Preservation of antigenic response as assessed by immunostaining neocortical adrenergic projection systems in the neocortex; (iii) The induction of increased auto-fluorescence in cortical tissue; and (iv) The retention of fluorescence in tissue from transgenic animals that expressed fluorescent proteins.

To test for integrity of cell surface membranes, laser ablated embryonic tissue was stained by the surface application of a fluorescent lipid analog and imaged with TPLSM. Under low magnification, there appeared to be no distortion of the brain topology, despite the prominent size of the lateral ventricle. Examination at higher magnification shows that a multitude of tissue types, including skin, bone and brain, have been cleanly cut. High magnification images of the ventricular zone in the lipid stained material reveals chains of neurons whose orientation, and shape is consistent with those from preparations of embryonic mouse cortex that have been frozen or hardened in embedding media for conventional histological sectioning.

The application of the water soluble stain acridine orange to laser ablated mouse cortex was observed to stain nucleic acids in both cell cytoplasm and nucleus. At high magnification of the ventricular zone examples of condensed chromosomes and of dividing cells with clear metaphase plates are in evidence, consistent with the known cell division that takes place at the base of the ventricular zone in mammalian cortex during its neurogenesis. These data demonstrate that all optical histology is a tool to ablate and image the embryonic brain with diffraction limited spatial resolution, as collateral damage from the ablation technology does not markedly distort brain structure down to the level of chromosomes.

The possibility of laser-induced increase in auto-fluorescence was considered, as this could limit the resolution of fluorescent labels from endogenous fluorophores in transgenic animals. Specifically, animals that expressed cameleon, a fusion protein that contains CFP in the walls of the cortical vasculature were used. The sample consisted of fixed tissue from neocortex of the transgenic animals in which a 100 micrometer wide channel was ablated. The direction of the imaging beam paralleled that used for the ablation. Maximum projections normal to the beam path were presented in order to assess the induction of auto-fluorescence near the ablated surface. When imaged at a wavelength of 750 nanometer, a relatively high level of auto-fluorescence may be seen in tissue that lies within 20 micrometer of the ablated surface. When imaged at a wavelength of 850 nanometer, labeled vasculature can be visualized down to a depth of approximately 150 micrometer below the ablated surface. Thus the increase in auto-fluorescence close to the ablated surface does not impede imaging deep into the tissue since this potential problem is circumvented by imaging with long wavelengths.

Iterative Volumetric Reconstruction of labeled tissue was tested by performing serial ablation and imaging of the fixed neocortex of CFP transgenic mice in which the neocortical vasculature in a medial region of parietal cortex is known to expresses CFP. Each stack of images comprised a total thickness of approximately 100 micrometer, and stacks from four iterations of cutting and imaging were overlaid to generate a 3-dimensional matrix of intensity values. The raw image data was band-pass filtered and processed with standard nonlinear routines to extract the edges of the walls. This process defines a reconstructed volume of the underlying vasculature that can be rotated for optimal viewing.

Methods for optimization of a particular embodiment of this technique

Tissue Preparation.

Adult animals of both sexes, both Sprague-Dawley rats, NIH Swiss mice, and transgenic mice, were perfused with phosphate buffered saline for the generation of fresh tissue. For the case of fixed tissue, the initial perfusion was immediately followed by a second perfusion with 4% (w/v) paraformaldehyde in phosphate buffered saline. The extracted brain was stored in 4% paraformaldehyde in phosphate buffered saline for post-fixation. Tissue from day E14 to E15 mouse pups was obtained from pregnant mice that were sacrificed with pentobarbital (50 milligram per gram mouse).

Transgenic mice were obtained that express yellow cameleon 3.0, a tandem fusion of the cyan-emitting mutant of the green fluorescent protein, a mutant calmodulin, the calmodulin-binding peptide M13, and an enhanced yellow-emitting green fluorescent protein. We observed mosaic expression of the fluorescent proteins in a manner that was consistent across multiple animals and generations. For the present work, the preferential labeling of vasculature in the neocortex is exploited.

Ablation Techniques

Source.

Pulses were derived from a Ti:Sapphire regenerative amplifier of local design, but other means of deriving the pulses are readily available. The amplifier was seeded with 100 femtosecond wide laser pulses at a wavelength of 800 nanometers and operated at a repetition rate was 1.2 kiloHertz. The amplified pulses had Gaussian pulse shape with a full width at half maximum of 100 femtosecond and energies up to 300 microJoule at the focus of the objective. The pulse energy that was delivered to the samples was controlled with the serial combination of a half-wave plate and a polarizing beam splitters. A two-lens telescope was then used to adjust the width of the beam so that it overfilled the back aperture of the objective.

Cutting.

All tissue ablations, with the exception of the fine channels in cortical tissue, were carried out in an aqueous environment. Fixed tissue ablations were carried out under a 1 to 3 millimeter layer of PBS that maintained the moisture of the tissue sample and, for the case of water-immersion objectives, formed a continuous layer with the lens. Hydrolysis bubbles, a byproduct of ablation in aqueous media, were removed by routinely breaking and reforming the aqueous contact with the objective. All cutting was at room temperature. In contrast, for fresh tissue the ablations were carried out in ACSF and maintained between 7° C. and 10° C. by chilled-water heat-exchange. Lastly, for the single case of non-aqueous ablation, the tissue was maintained at high humidity by partially enclosing the ablation chamber and purging the chamber with air that was humidified through an aqueous bubbling chamber.

Ablation involved gating the amplified laser pulses onto the sample and translating the sample underneath the objective. Positioning was controlled by an X-Y computer-driven motorized translation stage. In some cases, for increased ablation overlap, ablation channels were laterally interlaced between axial planes. Axial translation of the focus was achieved by moving the micrometer mounted objective holder along a vertically-mounted rail.

Visualization

Staining.

Subsequent to ablation, tissues were stained either with the lipid analog 5-hexadecanoylaminofluorescein to visualize the cell membranes, or with the nucleic acid stain acridine orange to emphasize the somata. The 5-hexadecanoylaminofluorescein was prepared as a 50 micromolar solution in 1% (v/v) ethanol in ACSF solution. The stain was bath applied for 3 minutes followed by 4 to 5 brief washes with physiological saline. The acridine orange was prepared as a 100 micromolar solution in deionized water. This stain was also bath applied for 3 minutes followed by 5 brief washes with saline. Note that fresh tissue was immersed in cold (4° C.) fixative overnight prior to staining.

Imaging.

Optical sectioning of all samples was performed with an upright two-photon laser scanning microscope. Four fluorescent indicators were used in the analysis of the tissue. Intrinsic auto-fluorescence was excited by wavelengths between 750 and 760 nanometers. Tissues that were stained with the lipid analog, 5-hexadecanoylaminofluorescein, were imaged at a wavelength of 800 nanometers. Tissues that were stained for nucleic acids with acridine orange were imaged at wavelengths at or above 800 nanometers. Lastly, the intrinsic fluorescent protein cyan fluorescent protein in the transgenic mice was imaged at a wavelength of 850 nanometer.

Volume Reconstruction. Individual optical sections were filtered to suppress noise and enhance contrast. The intensities of the separate sections were then normalized to permit volumetric operations. Our filtration involved four steps: First, the background noise, which was approximately white and Gaussian, was effectively suppressed by low-pass filtering. A 5×5 pixel (0.48 micrometer per pixel) square averaging kernel was utilized. It was convolved with the data in each section, and used reflecting boundaries to minimize edge effects. Second, the nonuniformity within each section was corrected by high-pass filtering. This operation involved subtraction of a heavily low-pass filtered version of the section, i.e., 81×81 pixel averaging kernel with reflecting boundaries, from the unfiltered data. Third, normalization of the data, along with suppression of the noise, was accomplished by a nonlinear mapping that removes a noise floor and also saturates at high intensities.

The resulting images have a large portion of pixels set to zero. The fourth and final step was to apply a double median filter, using a 5×5 square kernel of pixels, as a means to smooth edges, fill small voids, i.e., areas of low pixel value surrounded by larger areas of high pixel value, and remove isolated bright spots, i.e., small areas of non-zero values.

### Conclusion

Femtosecond laser pulses are used to iteratively cut and image fixed as well as exsanguinated fresh tissue. Such images help to automate three-dimensional histological analysis of biological tissue. Cuts are accomplished with 0.3 to 100 microJoule pulses to ablate tissue with one- micrometer precision. Permeability, immunoreactivity, and optical clarity of the remaining tissue is retained after pulsed laser cutting. Samples from transgenic mice that express fluorescent proteins retained their fluorescence to within micrometers of the cut surface.

Imaging of exogenous dyes that bind to specific proteins or nucleic acids, or imaging of endogenous fluorescent labels is accomplished with unamplified pulses and conventional TPLSM. Other means of optically obtaining the images may also be used, such as three or more-photon laser scanning microscopy. A stack of diffraction-limited images are obtained through a depth of 100 micrometers or more below the cut surface. The surface is then re-cut, optionally restained, and imaged until the entire block of tissue has been imaged and ablated. Three-dimensional spatial patterns of protein or nucleic acid expression are reconstructed with sub-micrometer resolution for the purposes of genomics, proteomics, and cellular architectonics. The technique is applied to neuronal tissue to reconstruct the microvasculature within a region of the brain.

Tissue is ablated and imaged in its native form at room temperature. Ablation is performed down to a precision of one micrometer in thickness, and thus avoids the necessity of freezing and embedding for thin cuts. No blocking or special preparation of tissue is required to perform a histology. The laser ablation does not significantly stress the tissue. Thus an entire rodent brain can be cut and imaged without blocking. Further, the laser ablation procedure may be used with fresh as well as fixated tissue.

In one embodiment, the tissue is stained in situ and optically sectioned between successively ablated surfaces, so that complete alignment between sections is retained. Typically, one hundred, one micrometer thick optical sections that span the 100 micrometers of tissue between successive ablations are acquired.

1. A method of imaging a three dimensional sample, the method comprising:
generating an image through an exposed surface of the sample;
ablating the sample to expose a lower exposed surface of the sample using short laser pulses; and
repeating the generation of images through lower exposed surfaces and ablating until a desired volume of the sample has been imaged.

2. The method of claim 1 wherein the image is generated using multi-photon laser scanning microscopy.

3. The method of claim 2 wherein the multi-photon laser generates pulses having a power sufficient to drive an optical nonlinearity that can be detected and used for image contrast.

4. The method of claim 1 wherein the short laser pulses comprise ultrashort pulses of width varying from femtoseconds to tens of picoseconds.

5. The method of claim I wherein the short laser pulses comprise pulses having an energy sufficient to reach and surpass the ablation threshold of the specimen to be imaged.

6. The method of claim 1 and further comprising staining the exposed surfaces prior to generating an image of them.

7. The method of claim 6 wherein staining comprises applying a fluorescent material to the exposed surfaces.

8. The method of claim 6 wherein staining comprises applying fluorescently labeled primary antibodies or immunoreactive antibody fragments to the exposed surfaces for immunocytochemical labeling of antigenic sites.

9. The method of claim 6 wherein staining comprises applying primary antibodies or immunoreactive antibody fragments to the exposed surfaces for immunocytochemical labeling of antigenic sites. The primary antibodies are subsequently labeled with fluorescently labeled secondary antibodies.

10. The method of claim 6 wherein staining comprises applying fluorescently labeled nucleic acid hybridization probes.

11. The method of claim 1 wherein a same objective and optics is used for the ablation and imaging.

12. The method of claim 1 wherein separate objectives are used for the ablation and imaging.

13. The method of claim 1 wherein an axial step size of approximately 5 to 20 micrometers of the sample is removed during each ablation.

14. The method of claim 1 wherein the short laser pulses are applied at a rate of between approximately 1 to 20 kiloHertz.

15. The method of claim 1 wherein the laser pulses have a wavelength of approximately between 750 to 850 nanometer.

16. The method of claim 1 wherein the laser pulses have a wavelength anywhere in the range between 200 nanometers and 10 micrometers.

17. The method of claim 1 wherein a objective lens having a numerical aperture of between approximately 0.2 to 1.0 NA is used to focus the short laser pulses on the sample.

18. The method of claim 1 wherein the sample is moved in a raster pattern.

19. The method of claim 1 and further comprising assembling images into a three dimensional model of the sample.

20. The method of claim 1 wherein the sample is ablated in a lateral or vertical cutting mode.

21. The method of claim 1 wherein the sample is biological tissue that is fixed.

22. The method of claim 21 wherein the sample is frozen, fresh, or stained.

23. A device for imaging a three dimensional sample, the device comprising:
means for generating an image of an exposed surface of the sample;
means for ablating the sample to expose a lower exposed surface of the sample using ultrashort laser pulses; and
means for automatic repetition of generating images of lower exposed surfaces and ablating until a desired volume of the sample has been imaged.

24. The device of claim 23 and further comprising means for creating a three dimensional representation of the sample from the images of iteratively exposed surfaces of the sample.

25. A method of imaging a three dimensional sample, the method comprising:
mounting the sample on a translation stage;
generating an image of an exposed surface of the sample using unamplified pulses from a laser through an objective lens;
ablating the sample to expose a lower exposed surface of the sample using high power ultrashort pulses from a laser through the same or lower numerical aperture objective lens; and
repeating the generation of images of lower exposed surfaces and ablating until a desired volume of the sample has been imaged.

26. The method of claim 25 and further comprising moving the sample relative to the laser pulses in a raster pattern using the translation stage.

27. The method of claim 25 and further comprising flowing a buffer solution over the sample.

28. A device for iteratively imaging and ablating a sample, the device comprising:
a sample platform that supports a sample;
an oscillator for imaging and possibly to seed the optical amplifier;
a pump laser for the oscillator;
an optical amplifier;
a pump laser for the amplifier;
optics for directing laser pulses to the sample for imaging of the sample; and
optics for directing laser pulses through the optical amplifier to provide high power laser pulses focused on the sample to ablate the sample.

29. The device of claim 28 with the laser beam directed by a computer controlled pair of scan mirrors.

30. The device of claim 28 and further comprising an objective lens for focusing laser pulses for imaging and ablation onto the sample.

31. The device of claim 30 wherein the objective lens has a high numerical aperture.

32. The device of claim 31 wherein the numerical aperture is between approximately 0.2 to 1.0 NA.

33. The device of claim 28 and further comprising separate lasers for generating the imaging and ablating laser pulses.

34. The device of claim 28 wherein said optical amplifier is a regenerative optical amplifier.

35. The device of claim 28 wherein said optical amplifier is a multi-pass optical amplifier.

36. The device of claim 28 wherein said optical amplifier is a semiconductor amplifier.

37. The device of claim 28 wherein said optical amplifier is an optical parametric amplifier.

38. The device of claim 28 wherein said optical amplifier is a fiber amplifier.

39. The device of claim 28 wherein said optical amplifier is a thin disk oscillator.

40. The device of claim 28 wherein the device is operated to perform automated histology on embryonic tissue.

41. The device of claim 28 wherein the device is operated to perform automated histology on transgenic animals with genetically encoded endogenous fluorophores.

42. The device of claim 28 wherein the device is operated to perform stereology and cell counting on tissue stained with dyes that bind to nucleic acids.

43. The device of claim 28 wherein the device is operated to perform reconstruction of extended structures in the brain, including but not limited to vasculature and tracts of axonal fibers.

44. The device of claim 28 and further comprising:
an enclosure for the sample; and
a translation stage coupled to the enclosure.

45. The device of claim 44 wherein the translation stage provides 5 degrees of motion.

46. The device of claim 44 wherein the enclosure contains an opening for sealing the objective lens.

47. The device of claim 44 wherein the enclosure contains nozzles for applying stain and buffer solution to the sample.

48. A device for iteratively imaging and ablating a sample, the device comprising:
a sample platform that supports a sample;
an optical amplifier;
an oscillator for imaging and optionally to seed the optical amplifier;
a pump laser for the oscillator;
a pump laser for the optical amplifier:
optics for directing laser pulses to the sample for imaging of the sample;
detectors for detecting light reflected from the sample from the laser pulses; and
optics for directing laser pulses through the optical amplifier to provide high power laser pulses focused on the sample to ablate the sample.

49. The device of claim 48 and further comprising a digital acquisition and storage device.

50. The device of claim 48 where an different wavelengths are used for imaging and ablating.

51. The device of claim 48 where endogenous signals are used for imaging.

52. The device of claim 48 where optical nonlinearities such as second harmonic generation, third harmonic generation, coherent anti-Stokes Raman generation, three-photon absorption fluorescence are used to generate image contrast.

53. The device of claim 48 where multiple beams are used to ablate tissue.

54. The device of claim 48 where multiple beams are used to image the sample.

55. The device of claim 48 where multiple beams are used simultaneously to image and ablate the sample.

56. The device of claim 48 where confocal microscopy is used for imaging the sample.

57. The device of claim 48 used as described, but on any optically dense specimen.
